(19) United States
(12) Patent Application Publication
(10) Pub. No.: US 2013/0088082 A1
(43) Pub. Date: Apr. 11, 2013

(54) WIRELESS POWER TRANSFERRING DEVICE, WIRELESS POWER RECEIVING DEVICE AND WIRELESS POWER TRANSFERRING AND RECEIVING DEVICE

(71) Applicants: Seung Youl KANG, Daejeon (KR); Yong Hae Kim, Daejeon (KR); Sang Hoon Cheon, Daejeon (KR); Myung Lae Lee, Daejeon (KR); Taehyoung Zyung, Daejeon (KR)

(72) Inventors: Seung Youl KANG, Daejeon (KR); Yong Hae Kim, Daejeon (KR); Sang Hoon Cheon, Daejeon (KR); Myung Lae Lee, Daejeon (KR); Taehyoung Zyung, Daejeon (KR)

(73) Assignee: ELECTRONICS AND TELECOMMUNICATIONS RESEARCH INSTITUTE, Daejeon (KR)

(21) Appl. No.: 13/486,669

(22) Filed: Jun. 1, 2012

(30) Foreign Application Priority Data
Oct. 11, 2011 (KR) 10-2011-0103453

(51) Int. Cl. H02J 3/32

(52) U.S. Cl. 307/48

(57) ABSTRACT

Disclosed is a wireless power transferring device which includes a power generating unit configured to generate a power using a solar battery; a power charging unit including a super capacitor or a battery and configured to charge the generated power to retain a power; and a transmission unit configured to convert the power of the charging unit into a high frequency to send the high frequency wirelessly.

### CROSS-REFERENCE TO RELATED APPLICATIONS

A claim for priority under 35 U.S.C. §119 is made to Korean Patent Application No. 10-2011-0103453 filed Oct. 11, 2011, in the Korean Intellectual Property Office, the entire contents of which are hereby incorporated by reference.

### BACKGROUND

The inventive concepts described herein relate to a wireless power transferring device using a wireless power transfer manner, a wireless power receiving device, and a wireless power transferring and receiving device, and more particularly, to a wireless power transferring device transferring a power, generated using a solar battery, in wireless, a wireless power receiving device, and a wireless power transferring and receiving device.

In recent years, use of handheld devices may have been expanded thanks to advancement of the information communication technology. Persons may get many advantages if a power is provided at public places using a wireless transfer technique.

A magnetic induction method may have been used as a wireless power transferring method. With the magnetic induction method, however, power transfer efficiency may be sharply lowered according to a distance. On the other hand, a resonance-type wireless power transfer technique may be characterized in that transfer efficiency is reduced linearly according to a distance. Thus, the resonance-type wireless power transfer technique may be suitable for long power transfer.

### SUMMARY

Example embodiments of the inventive concept provide a wireless power transferring device comprising a power generating unit configured to generate a power using a solar battery; a power charging unit including a super capacitor or a battery and configured to charge the generated power to retain a power; and a transmission unit configured to convert the power of the charging unit into a high frequency to send the high frequency wirelessly.

In example embodiments, the power generating unit further comprises a generator configured to accessorily generate a power.

In example embodiments, the transmission unit is configured to adjust a resonant frequency.

Example embodiments of the inventive concept also provide a wireless power receiving device comprising a receiving unit configured to receive a high frequency from a wireless power transferring device; a charging unit configured to charge the input power using a super capacitor; and an internal circuit configured to be supplied with the charged power.

In example embodiments, the receiving unit adjusts a resonant frequency.

In example embodiments, the receiving unit includes a buffer circuit configured to prevent an overvoltage.

In example embodiments, the wireless power receiving device further comprises a battery configured to receive a power from the charging unit to supply the power to an internal circuit.

Example embodiments of the inventive concept also provide a wireless power transferring and receiving device comprising a wireless power transferring device which generates a power using a solar battery, keeps the generated power using a super capacitor or a battery, and converts the kept power into a high frequency to transfer the high frequency wirelessly; and a wireless power receiving device which receives a transferred power and charges the input power using a super capacitor to keep the charged power.

In example embodiments, the wireless power receiving device is a handheld electronic device.

In example embodiments, the wireless power receiving device is a handheld telephone.

In example embodiments, the wireless power receiving device is a portable computer.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a wireless power transferring device according to an embodiment of the inventive concept.

FIG. 2 is a block diagram schematically illustrating a wireless power transferring device according to another embodiment of the inventive concept.

FIG. 3 is a block diagram schematically illustrating a wireless power receiving device according to an embodiment of the inventive concept.

FIG. 4 is a block diagram schematically illustrating a wireless power transferring and receiving device according to an embodiment of the inventive concept.

FIG. 5 is a block diagram schematically illustrating a wireless power transferring and receiving device according to another embodiment of the inventive concept.

FIG. 6 is a block diagram schematically illustrating a wireless power transferring and receiving device according to still another embodiment of the inventive concept.

FIG. 7 is a block diagram schematically illustrating a wireless power transferring and receiving device according to still another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

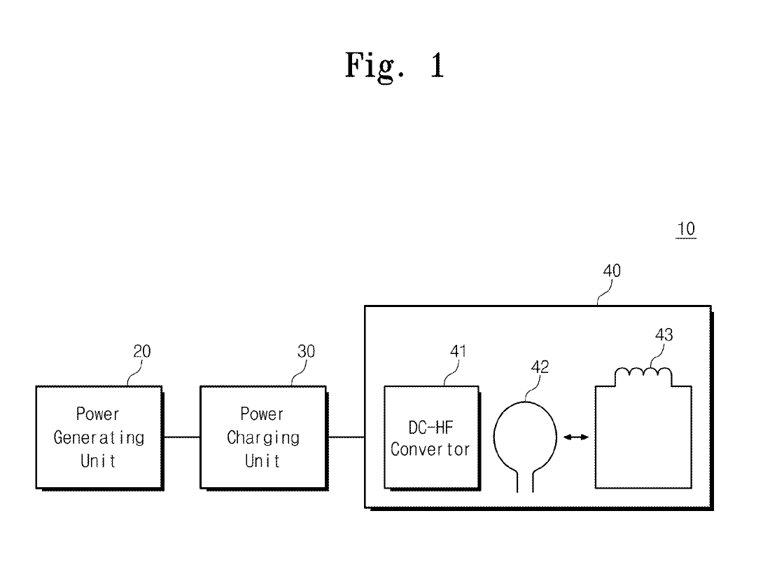

FIG. 1 is a block diagram schematically illustrating a wireless power transferring device according to an embodiment of the inventive concept. Referring to FIG. 1, a wireless power transferring device 10 may include a power generating unit 20, a power charging unit 30, and a transmission unit 40 configured to transmit a power charged at the power charging unit 30.

The power generating unit 20 may be configured to generate a power to be used for wireless power charge. The wireless power transferring device 10 may not transmit a power when no power receiving device exists nearby or when the power receiving device need not receive a power. In this case, leakage of the generated power may arise. For this reason, there may be required a power charging unit that stores the generated power directly and supplies it to a power transferring device.

The power charging unit 30 may charge a power generated by the power generating unit 20. That is, the power charging unit 30 may conduct a role of storing a power.

The transmission unit 40 may receive a power from the power charging unit 30. The transmission unit 40 may transmit a power in an electromagnetic wave having a specific frequency. The frequency of the electromagnetic wave may be variable. The transmission unit 40 may be configured to transmit at least one or more frequencies. The transmission unit 40 may transfer a power non-continuously. This may enable a power from being consumed unnecessarily when a power transfer is required from the transmission unit 40. Thus, it is possible to improve the power transfer efficiency.

The transmission unit 40 may include a direct current (DC) to high frequency (HF) convertor (hereinafter, referred to as DC-HF convertor) 41, a power coil 42, and a transfer coil 43. The DC-HF convertor 41 may convert a DC voltage provided from the power charging unit 30 into a high frequency voltage. The power coil 42 may transfer the high frequency voltage to the transfer coil 43 through magnetic resonance. The transfer coil 43 may send the high frequency voltage to a receiving device (not shown).

As understood from the above description, the wireless transferring device according to an embodiment of the inventive concept may be configured to generate, store, and transmit a power. To realize the above-described functions efficiently, the power generating unit 20 need generate a firm power by a low cost. Also, the power charging unit need be configured to have a quick charging speed and a large charging capacity.

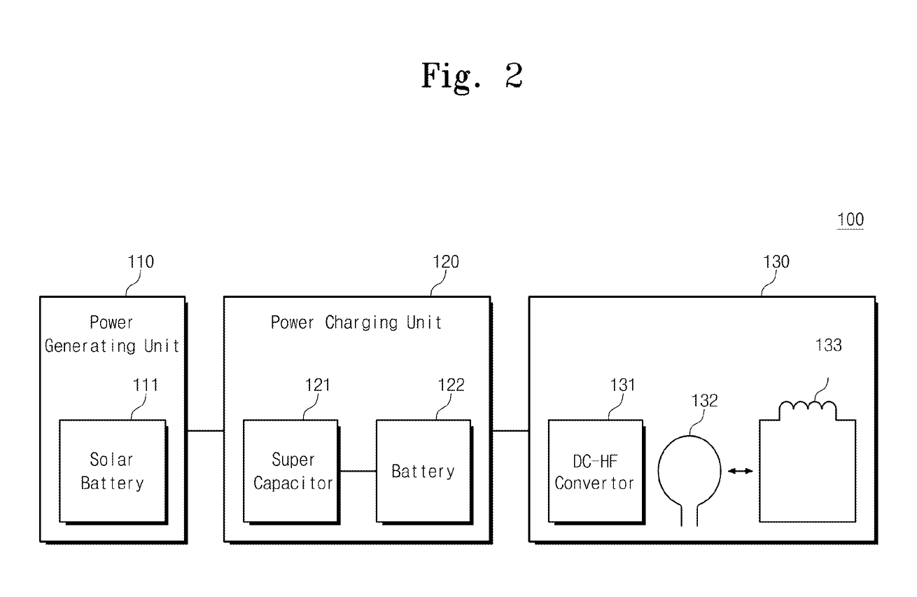

FIG. 2 is a block diagram schematically illustrating a wireless power transferring device according to another embodiment of the inventive concept.

Referring to FIG. 2, a power generating unit 110 may include a solar battery 111. The solar battery 111 may be formed of silicon solar cells, thin film solar cells, dye-sensitized solar cells (DSSCs), and the like. In example embodiments, the dye-sensitized solar cells may be used to form the solar battery. The dye-sensitized solar cells may be characterized in that electricity is generated under a circumstance such as low intensity of lightness such as the interior illumination. Also, the dye-sensitized solar cells may be formed of cheap raw substance and may not necessitate vacuum coating at a process level. That is, the dye-sensitized solar cells may be economic. Thus, it is easy to supply a power immediately and economically through constant electricity generation.

The power charging unit 120 may be charged by a power generated by the power generating unit 110. That is, the power charging unit 120 may play a role of storing a power. The power charging unit 120 may include a super capacitor 121 and a battery 122.

A capacity of the super capacitor 121 may be smaller than that of the battery 122. However, the super capacitor 121 may have quick charging and discharging speeds. The super capacitor 121 may enable a power to be stored and transferred immediately. The super capacitor 121 may correspond to continuous charging and discharging using a long life.

A response speed of the battery 122 may be slower than that of the super capacitor 121. However, a capacity of the battery 122 may be larger than that of the super capacitor 121. A power generated by the power generating unit 110 may be first charged fully at the super capacitor 121, and may be then charged at the battery 122. The battery 122 may be formed of a lead-acid battery, a Ni—Cd battery, a nickel-cadmium battery, a Ni-Mh storage battery, and the like. With this charging manner, the transmission unit 130 may stably supply a power although no power is supplied from the solar battery of the power generating unit 110.

The transmission unit 130 may include a DC-HF convertor 131, a power coil 132, and a transfer coil 133. The DC-HF convertor 131 may receive a DC power charged at the power charging unit 120 to convert it into an AC signal having a radio frequency.

The power coil 132 may receive a power from the DC-HF convertor 131. The power input manner of the power coil 132 may not be limited thereto. For example, the power coil 132 may be supplied with a power through a magnetic induction manner. The power coil 132 may be formed of a coil having a diameter of more than 3 mm to reduce the loss of a power due to resistance. Further, the power coil 132 may have a less turn number to reduce the loss of a power due to resistance. However, the power coil 132 is not limited to this disclosure.

The transfer coil 133 may receive a power from the power coil 132 to transmit it. The transfer coil 133 may have an inherent frequency, and may resonate through magnetic induction with the power coil 132 to generate a non-radiated electromagnetic wave. Thus, a resonant frequency of the transfer coil 133 may be equal to that of the power coil 132. The transfer coil 133 may be located to be closest to the power coil 132 for the power transfer efficiency from the power coil 132. In example embodiments, the transfer coil 133 may be formed of a coil having a diameter of more than 3 mm to reduce the loss of a power due to resistance.

The wireless power transferring device according to an embodiment of the inventive concept may generate a firm power always with a low cost. The wireless power transferring device may simultaneously transmit a power to many people by storing a generated power quickly. Thus, for the use of the public, the wireless power transferring device may be installed at public places such as a bus station, a park, and the like

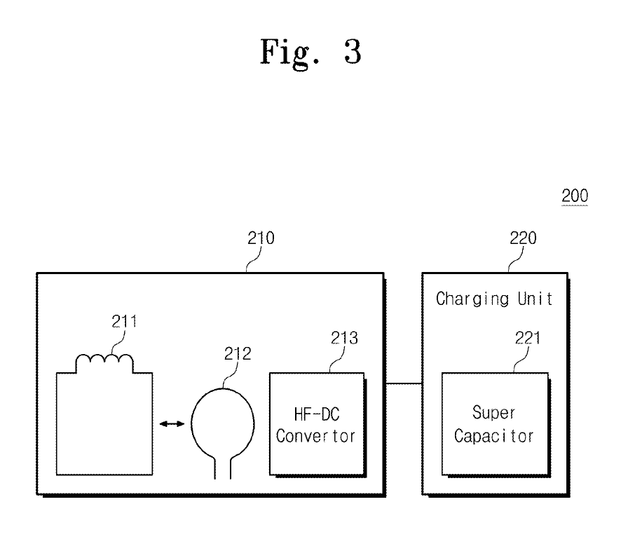

FIG. 3 is a block diagram schematically illustrating a wireless power receiving device according to an embodiment of the inventive concept. Referring to FIG. 3, a wireless power receiving device may include a receiving unit 210 and a charging unit 220.

The receiving unit 210 may receive a non-radiated electromagnetic wave transmitted from a transmission unit. The receiving unit 210 may include a receiving coil 211, a load coil 212, and a HF-DC convertor 213. The receiving unit 210 may further include a buffer circuit (not shown) that prevents an overvoltage due to overcharging of the receiving device.

The receiving coil 211 may receive a non-radiated electromagnetic wave transferred from a transmission unit. At this time, the receiving coil 211 may resonate at the same frequency as a transfer coil. That is, the receiving coil 211 may be supplied with a power with magnetic coupling with the transmission unit.

The load coil 212 may store a power received from the receiving coil 211. The load coil 212 may be supplied with a power through magnetic induction from the receiving coil 211. Thus, the load coil 212 may be desirably located at a position adjacent to the receiving coil 211.

The HF-DC convertor 213 may convert electromagnetic waves stored at the load coil 212 into a direct current.

The charging unit 220 may charge a power received from the HF-DC convertor 213 in a short time. The charging unit 220 may include a super capacitor 221. The charging unit 220 may quickly charge a little power using the super capacitor 221. It may be used when urgent power transfer and charge are needed. Further, the charging unit 220 may include a battery. Thus, the charging unit 220 may perform quick charging using the super capacitor 221 and charge a power stably using the battery.

As understood from the above description, the wireless power receiving device according to an embodiment of the inventive concept may be supplied with a power in a wireless manner. Also, the wireless power receiving device may be quickly charged by the transmitted power through the charging unit 220.

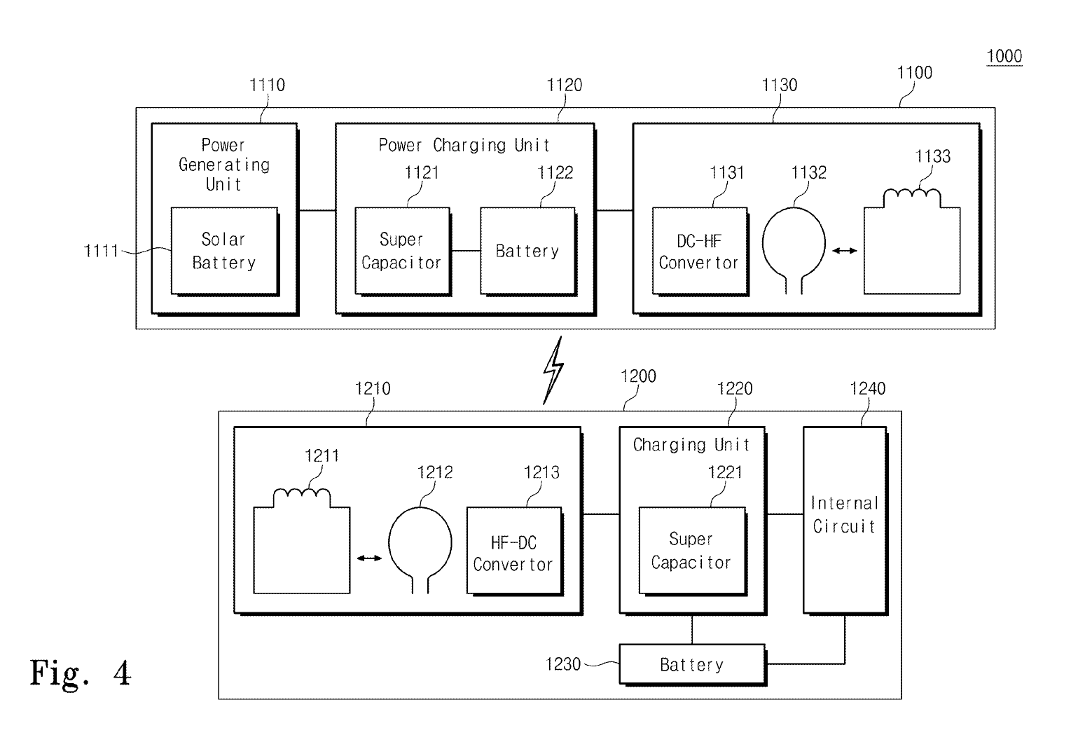

FIG. 4 is a block diagram schematically illustrating a wireless power transferring and receiving device according to an embodiment of the inventive concept. A wireless power transferring and receiving device 1000 in FIG. 4 may include a wireless power transferring device 1100 and a wireless power receiving device 1200. The wireless power transferring device 1100 may include a power generating unit 1110 having a solar battery 1111, a power charging unit 1120 having a super capacitor 1121 and a battery 1122, and a transmission unit 1130 having a DC-HF convertor 1131, a power coil 1132, and a transfer coil 1133. The wireless power receiving device 1200 may include a receiving unit 1210 having a receiving coil 1211, a load coil 1212, and a HF-DC convertor 1213, a charging unit 1220 having a super capacitor 1221, a battery 1230, and an internal circuit 1240. The wireless power transferring device 1100 in FIG. 4 is substantially equal to that in FIG. 2, and the wireless power receiving device 1200 in FIG. 4 is substantially equal to that in FIG. 2 except that the battery 1230 and the internal circuit 1240 are added.

Referring to FIG. 4, a power transfer between the wireless power transferring device 1100 and the wireless power receiving device 1200 may be made according to a resonance-type wireless power transfer manner. When two mediums resonate at the same frequency, a non-radiated wireless energy transfer may be made by the evanescent wave coupling in which an electromagnetic wave is shifted to one medium from the other medium through a close electromagnetic field. Thus, energy may be transferred when resonant frequencies of two mediums are equal to each other. Unused energy may be re-absorbed by the electromagnetic field without radiation to air. That is, it may be efficient.

The battery 1230 may store a power charged at the charging unit 1220, and may provide the stored power to the internal circuit 1240. The internal circuit 1240 may be formed of elements consuming a power of the wireless power receiving device 1200.

The wireless power transferring and receiving device according to an embodiment of the inventive concept may transfer and receive a power efficiently in a long distance. Also, the wireless power transferring and receiving device may slightly affect peripheral devices or human bodies compared with a wireless power transferring and receiving device using another electromagnetic wave transfer technique.

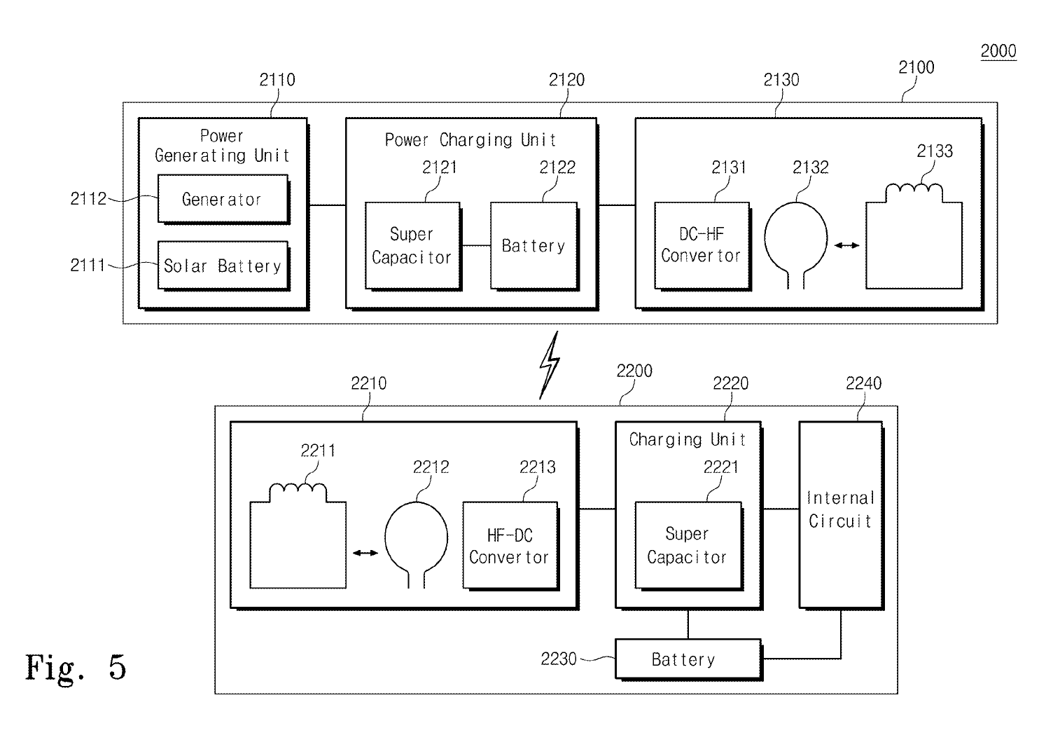

FIG. 5 is a block diagram schematically illustrating a wireless power transferring and receiving device according to another embodiment of the inventive concept. A wireless power transferring and receiving device 2000 in FIG. 5 may include a wireless power transferring device 2100 and a wireless power receiving device 2200. The wireless power transferring device 2100 may include a power generating unit 1110 having a solar battery 2111 and a generator 2112, a power charging unit 2120 having a super capacitor 2121 and a battery 2122, and a transmission unit 2130 having a DC-HF convertor 2131, a power coil 2132, and a transfer coil 2133. The wireless power receiving device 2200 may include a receiving unit 2210 having a receiving coil 2211, a load coil 2212, and a HF-DC convertor 2213, a charging unit 2220 having a super capacitor 2221, a battery 2230, and an internal circuit 2240. The wireless power transferring and receiving device 2000 in FIG. 5 is substantially equal to that in FIG. 4 except that the power generating unit 2110 includes the generator 2112, and similar constituent elements are marked by similar reference numerals.

Referring to FIG. 5, the wireless power transmitting and receiving device 2000 may be configured such that the power generating unit 2110 includes the generator 2112. The generator 2112 may be formed of a wind power generator, hydroelectric power generator, a general power supplier, and the like. However, the generator 2112 is not limited to this disclosure. The wireless power transferring and receiving device 2000 may continue to supply a power even at the case that a power charged at the charging unit 2120 is all consumed and no electricity is generated using solar thermal.

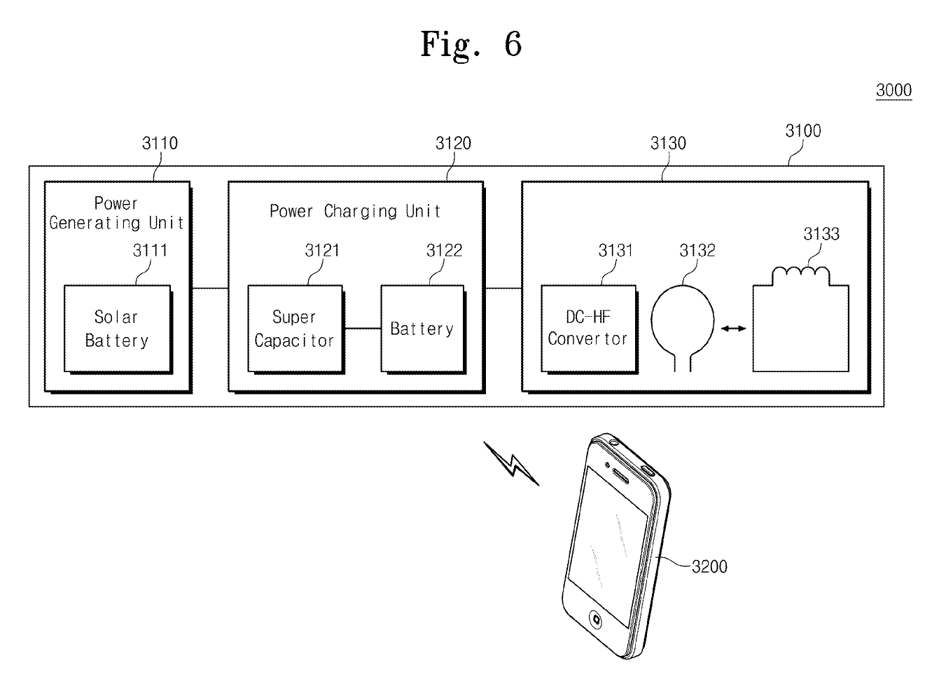

FIG. 6 is a block diagram schematically illustrating a wireless power transferring and receiving device according to still another embodiment of the inventive concept. A wireless power transferring and receiving device 3000 in FIG. 6 may include a wireless power transferring device 3100 and a wireless power receiving device 3200. The wireless power transferring device 3100 may include a power generating unit 3110 having a solar battery 3111, a power charging unit 3120 having a super capacitor 3121 and a battery 3122, and a transmission unit 3130 having a DC-HF convertor 3131, a power coil 3132, and a transfer coil 3133. The wireless power transferring and receiving device 3000 in FIG. 6 is substantially equal to that in FIG. 4, and similar elements are marked by similar reference numerals. As illustrated in FIG. 6, the wireless power receiving device 3200 may be a smartphone.

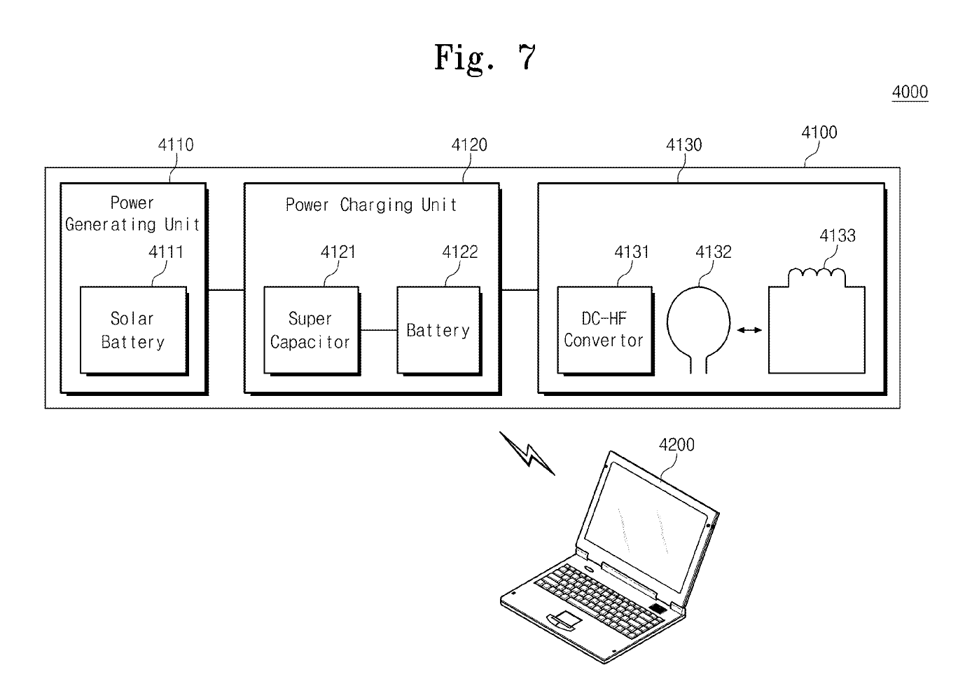

FIG. 7 is a block diagram schematically illustrating a wireless power transferring and receiving device according to still another embodiment of the inventive concept. A wireless power transferring and receiving device 4000 in FIG. 7 may include a wireless power transferring device 4100 and a wireless power receiving device 4200. The wireless power transferring device 4100 may include a power generating unit 4110 having a solar battery 4111, a power charging unit 4120 having a super capacitor 4121 and a battery 4122, and a transmission unit 4130 having a DC-HF convertor 4131, a power coil 4132, and a transfer coil 4133. The wireless power transferring and receiving device 4000 in FIG. 7 is substantially equal to that in FIG. 4, and similar elements are marked by similar reference numerals. As illustrated in FIG. 7, the wireless power receiving device 3200 may be formed of a portable computer including a tablet PC and a handheld device.

As described above, a wireless power transferring and receiving device according to an embodiment of the inventive concept may include a power generating unit which is configured to always generate a power economically. Further, it is possible to continuously store the generated power and to charge a receiving device quickly. Thus, the wireless power transferring and receiving device according to an embodiment of the inventive concept may be used as a public quick charge device for handheld devices that always operates at a public place.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A wireless power transferring device comprising:
a power generating unit configured to generate a power using a solar battery;
a power charging unit including a super capacitor or a battery and configured to charge the generated power to retain a power; and
a transmission unit configured to convert the power of the charging unit into a high frequency to send the high frequency wirelessly.

2. The wireless power transferring device of claim 1, wherein the power generating unit further comprises a generator configured to accessorily generate a power.

3. The wireless power transferring device of claim 1, wherein the transmission unit is configured to adjust a resonant frequency.

4. A wireless power receiving device comprising:
a receiving unit configured to receive a high frequency from a wireless power transferring device;
a charging unit configured to charge the input power using a super capacitor; and
an internal circuit configured to be supplied with the charged power.

5. The wireless power receiving device of claim 4, wherein the receiving unit adjusts a resonant frequency.

6. The wireless power receiving device of claim 4, wherein the receiving unit includes a buffer circuit configured to prevent an overvoltage.

7. The wireless power receiving device of claim 4, further comprising:
a battery configured to receive a power from the charging unit to supply the power to an internal circuit.

8. A wireless power transferring and receiving device comprising:
a wireless power transferring device which generates a power using a solar battery, keeps the generated power using a super capacitor or a battery, and converts the kept power into a high frequency to transfer the high frequency wirelessly; and
a wireless power receiving device which receives a transferred power and charges the input power using a super capacitor to keep the charged power.

9. The wireless power transferring and receiving device of claim 8, wherein the wireless power receiving device is a handheld electronic device.

10. The wireless power transferring and receiving device of claim 8, wherein the wireless power receiving device is a handheld telephone.

11. The wireless power transferring and receiving device of claim 8, wherein the wireless power receiving device is a portable computer.
